(19) United States
(12) Patent Application Publication
(10) Pub. No.: US 2022/0091361 A1
(43) Pub. Date: Mar. 24, 2022

(54) Camera Module, Camera, and Mobile Terminal

(71) Applicant: Huawei Technologies Co., Ltd., Shenzhen (CN)

(72) Inventors: Feng Zhen, Dongguan (CN); Li-Te Kuo, Dongguan (CN); Chuan Yang, Dongguan (CN); Ruiming Ding, Dongguan (CN); Jun Xie, Dongguan (CN)

(21) Appl. No.: 17/543,313

(22) Filed: Dec. 6, 2021

Related U.S. Application Data
(63) Continuation of application No. PCT/CN2020/094089, filed on Jun. 3, 2020.

(30) Foreign Application Priority Data
Jun. 6, 2019 (CN) 201910491991.0

(51) Int. Cl. G02B 7/09; G03B 5/00; G02B 27/64; G03B 30/00; G03B 13/36

(52) U.S. Cl. CPC G02B 7/09; G03B 5/00; G03B 2205/0007; G03B 30/00; G03B 13/36; G02B 27/646

(57) ABSTRACT

A camera system includes a camera lens assembly, a motor circuit board, and an image sensor, where the motor circuit board and the camera lens assembly each have a light passing hole, the camera lens assembly is located between the image sensor and the motor circuit board, a light-sensitive surface of the image sensor is located on an image side of the camera lens assembly, and the motor circuit board is located on an object side of the camera lens assembly.

### CROSS-REFERENCE TO RELATED APPLICATIONS

This is a continuation of International Patent Application No. PCT/CN2020/094089 filed on Jun. 3, 2020, which claims priority to Chinese Patent Application No. 201910491991.0 filed on Jun. 6, 2019. The disclosures of the aforementioned applications are hereby incorporated by reference in their entireties.

### TECHNICAL FIELD

This application relates to the field of communication technologies, and specifically, to a camera module, a camera, and a mobile terminal.

### BACKGROUND

In an existing intelligent device, a camera module basically implements auto focus, zoom, and image stabilization by driving movement of a camera lens by using a motor mechanism. However, a motor carrier needs to drive the camera lens to move for a specific distance. Therefore, a space needs to be reserved for the movement of the camera lens in the intelligent device. A smartphone is used as an example. As the smartphone is increasingly thinner, an available space that can be left for a camera module in the smartphone becomes increasingly smaller. However, a motor carrier needs to use a magnet to drive a coil to generate thrust, so as to drive a camera lens to move longitudinally. In this case, the magnet occupies a relatively large volume inside a motor, and to make the thrust reach a specific value, it is difficult to further reduce a volume of the magnet. Therefore, a structure of the motor needs to be improved and a volume of the motor needs to be reduced without reducing the volume of the magnet, so as to reduce a volume of the camera module in the mobile phone.

After a shape memory alloy (SMA) is heated, deformation occurring at a relatively low temperature can be eliminated, and an original shape of the shape memory alloy before deformation can be restored. Therefore, the movement of the camera lens may be driven by using a motor driven by an SMA wire. Compared with a conventional motor, the SMA wire has a smaller volume, and can effectively reduce an overall size of a module, thereby facilitating miniaturization development of the module. However, because a motor circuit board is generally disposed inside the motor, and the motor is generally located above an image sensor, the motor circuit board is very close to the image sensor. After being driven by a pulse width modulation (PWM) driving signal, the SMA wire produces electromagnetic interference to the image sensor, and stripe noise occurs on a captured photo. Therefore, it is urgent to design a camera module that can reduce the stripe noise.

### SUMMARY

Embodiments of this application provide a camera module, so that electromagnetic interference can be reduced, and stripe noise can be reduced.

To achieve the foregoing objectives, the embodiments of this application provide the following technical solutions.

A first aspect of this application provides a camera module. The camera module may include a camera lens assembly, a motor circuit board, and an image sensor, where the motor circuit board and the camera lens assembly each have a light passing hole, the camera lens assembly is located between the image sensor and the motor circuit board, a light-sensitive surface of the image sensor is located on an image side of the camera lens assembly, and the motor circuit board is located on an object side of the camera lens assembly. It can be learned from the first aspect that, the motor circuit board is disposed at a position far away from the image sensor. Further, the motor circuit board is located on the object side of the camera lens assembly, to increase a physical distance between the motor circuit board and the image sensor, thereby greatly reducing stripe noise.

Optionally, with reference to the first aspect, in a first possible implementation, the camera lens assembly may include a camera lens and a motor, where the motor may include a movable part, a fastener, a camera lens support, and an actuator, one end of the camera lens support is fastened to the fastener, and the other end thereof is configured to support the movable part, a light passing hole is provided on the movable part, and the movable part is configured to mount the camera lens, one end of the actuator is connected to the fastener, and the other end of the actuator drives the movable part when the actuator is driven by a signal, the fastener may include a base and a positioning component, the base has a light passing hole, the base is located on the image side of the camera lens assembly, one end of the positioning component is fastened to the base, and the other end thereof is fastened to the motor circuit board, and there is an accommodating space between the motor circuit board and the motor, and the accommodating space is used to accommodate an electronic device on the motor circuit board.

Optionally, with reference to the first aspect, in a second possible implementation, the camera module may further include a housing, and the camera lens assembly may include a camera lens and a motor, where a light passing hole is provided on a surface that is of the housing and that corresponds to the camera lens, one end of a camera lens support is fastened to a fastener, and the other end thereof is configured to support a movable part, a light passing hole is provided on the movable part, and the movable part is configured to mount the camera lens, one end of an actuator is connected to the fastener, and the other end of the actuator drives the movable part when the actuator is driven by a signal, and the motor circuit board is located on a side that is of the housing and that has the light passing hole.

Optionally, with reference to the first aspect, the first possible implementation of the first aspect, or the second possible implementation of the first aspect, in a third possible implementation, a diameter of the light passing hole of the motor circuit board is greater than a diameter of the camera lens.

Optionally, with reference to the first aspect, the first possible implementation of the first aspect, or the second possible implementation of the first aspect, in a fourth possible implementation, the camera module may further include a shielding plate, the shielding plate has a light passing hole, and the shielding plate is fitted with the motor circuit board.

Optionally, with reference to the first aspect, the first possible implementation of the first aspect, or the second possible implementation of the first aspect, in a fifth possible implementation, the motor is a motor driven by an SMA, and the motor driven by the SMA may include a movable part, a fastener, a camera lens support, and an SMA wire, where one end of the camera lens support is fastened to the fastener, and the other end thereof is configured to support the movable part, a light passing hole is provided on the movable part, and the movable part is configured to mount the camera lens, one end of the SMA wire is connected to the fastener, and the other end of the SMA wire is connected to the movable part, the fastener includes a base and a positioning component, the base has a light passing hole, the base is located on the image side of the camera lens assembly, one end of the positioning component is fastened to the base, and the other end thereof is fastened to the motor circuit board, and there is an accommodating space between the motor circuit board and the motor, and the accommodating space is used to accommodate an electronic device on the motor circuit board.

Optionally, with reference to the first aspect, the first possible implementation of the first aspect, or the second possible implementation of the first aspect, in a sixth possible implementation, the motor is a piezoelectricity-driven motor, and the motor includes a movable part, a fastener, a camera lens support, and a piezoelectric actuator, where one end of the camera lens support is fastened to the fastener, and the other end thereof is configured to support the movable part, a light passing hole is provided on the movable part, and the movable part is configured to mount the camera lens, the piezoelectric actuator includes a piezoelectric material and a resonator, the piezoelectric material is fastened onto the resonator, and one end of the resonator is fixedly connected to the fastener and the other end thereof is in contact with the movable part, or one end of the resonator is in contact with the fastener and the other end thereof is fixedly connected to the movable part, the fastener includes a base and a positioning component, the base has a light passing hole, the base is located on the image side of the camera lens assembly, one end of the positioning component is fastened to the base, and the other end thereof is fastened to the motor circuit board, and there is an accommodating space between the motor circuit board and the motor, and the accommodating space is used to accommodate an electronic device on the motor circuit board.

A second aspect of this application provides a camera module. The camera module may include a camera lens assembly, a motor circuit board, and an image sensor, where the camera lens assembly has a light passing hole, the image sensor and the motor circuit board are located on different sides of the camera lens assembly, the image sensor, the camera lens assembly, and the motor circuit board are not in a same direction, and the camera lens assembly includes a camera lens and a motor, where the motor is a motor driven by a SMA, and the motor driven by the SMA includes a movable part, a fastener, a camera lens support, and an SMA wire, one end of the camera lens support is fastened to the fastener, and the other end thereof is configured to support the movable part, a light passing hole is provided on the movable part, and the movable part is configured to mount the camera lens, and one end of the SMA wire is connected to the fastener, and the other end of the SMA wire is connected to the movable part.

Optionally, with reference to the second aspect, in a first possible implementation, the fastener may include a base and a baffle, the base has a light passing hole, the base is located on an image side of the camera lens assembly, one end of the baffle is connected to the base, the other end thereof is far away from the base, and a surface between two ends of the baffle is fixedly connected to the motor circuit board.

Optionally, with reference to the second aspect, in a second possible implementation, the camera module may further include a housing, a light passing hole is provided on a surface that is of the housing and that corresponds to the camera lens, the motor circuit board is located on a side surface of the housing, and the side surface is connected to a side that is of the housing and that has a through hole.

A third aspect of this application provides a camera module. The camera module may include a camera lens assembly, a motor circuit board, and an image sensor, where the camera lens assembly has a light passing hole, the image sensor and the motor circuit board are located on different sides of the camera lens assembly, the image sensor, the camera lens assembly, and the motor circuit board are not in a same direction, and the camera lens assembly may include a camera lens and a motor, where the motor is a piezoelectricity-driven motor, and the motor may include a movable part, a fastener, a camera lens support, and a piezoelectric actuator, one end of the camera lens support is fastened to the fastener, and the other end thereof is configured to support the movable part, a light passing hole is provided on the movable part, and the movable part is configured to mount the camera lens, and the piezoelectric actuator may include a piezoelectric material and a resonator, the piezoelectric material is fastened onto the resonator, and one end of the resonator is fixedly connected to the fastener and the other end thereof is in contact with the movable part, or one end of the resonator is in contact with the fastener and the other end thereof is fixedly connected to the movable part.

Optionally, with reference to the third aspect, in a first possible implementation, the fastener may include a base and a positioning component, the base has a light passing hole, the base is located on an image side of the camera lens assembly, one end of the positioning component is fastened to the base, the other end thereof is fastened to the motor circuit board, there is an accommodating space between the motor circuit board and the motor, and the accommodating space is used to accommodate an electronic device on the motor circuit board.

Optionally, with reference to the third aspect, in a second possible implementation, the camera module may further include a housing, a light passing hole is provided on a surface that is of the housing and that corresponds to the camera lens, the motor circuit board is located on a side surface of the housing, and the side surface is connected to a side that is of the housing and that has a through hole.

A fourth aspect of this application provides a camera. The camera may include a camera body, a main board, a first mounting part, and a camera module, where the first mounting part is disposed on the camera body, and is configured to detachably assemble the camera module; and the camera module is electrically connected to the main board, and the camera module is the camera module described in the first aspect to the third aspect of this application.

A fifth aspect of this application provides a mobile terminal. The mobile terminal may include a housing, a main board, and a camera module, where the main board is disposed in the housing, a camera of the camera module is disposed at a camera hole of the housing, the camera module is electrically connected to the main board, and the camera module is the camera module described in the first aspect to the third aspect of this application.

According to the technical solutions of this application, the motor circuit board is disposed at a position far away from the image sensor. Further, the motor circuit board is located on the object side of the camera lens assembly, so that electromagnetic interference can be reduced, and stripe noise can be reduced.

### BRIEF DESCRIPTION OF DRAWINGS

FIG. 1 is a first schematic diagram of a structure of a camera module according to an embodiment of this application;

FIG. 2 is a second schematic diagram of a structure of a camera module according to an embodiment of this application;

FIG. 3 is a schematic diagram of a camera lens assembly according to an embodiment of this application;

FIG. 4 is a schematic diagram of a first fastening manner of a motor circuit board according to an embodiment of this application;

FIG. 5 is a schematic diagram of a second fastening manner of a motor circuit board according to an embodiment of this application;

FIG. 6 is a schematic diagram of a third fastening manner of a motor circuit board according to an embodiment of this application;

FIG. 7 is a schematic diagram of a fourth fastening manner of a motor circuit board according to an embodiment of this application;

FIG. 8 is a schematic diagram of a fifth fastening manner of a motor circuit board according to an embodiment of this application;

FIG. 9 is a schematic diagram of a sixth fastening manner of a motor circuit board according to an embodiment of this application;

FIG. 10 is a schematic diagram of a structure of a motor according to an embodiment of this application;

FIG. 11 is a first schematic diagram of a structure of a fastener of a motor according to an embodiment of this application;

FIG. 12 is a second schematic diagram of a structure of a fastener of a motor according to an embodiment of this application;

FIG. 13 is a schematic diagram of a connection manner between a motor and a motor circuit board according to an embodiment of this application;

FIG. 14 is a schematic diagram of another connection manner between a motor and a motor circuit board according to an embodiment of this application; and

FIG. 15 is a schematic diagram of another connection manner between a motor and a motor circuit board according to an embodiment of this application.

### DESCRIPTION OF EMBODIMENTS

Embodiments of this application provide a camera module, to avoid an electromagnetic interference problem caused by a close distance from an SMA motor and wiring thereof to an image sensor and an analog power supply after the motor is driven by a PWM driving signal. The embodiments of this application further provide a corresponding camera and a terminal device. Details are described in the following.

For a better understanding of this application, aspects of this application are described in more detail with reference to the accompanying drawings. It should be understood that, these detailed descriptions are merely descriptions of examples of implementations in this application, and are not intended to limit the scope of this application in any manner. In the full text of this specification, the same reference numerals refer to the same elements. The expression “and/or” includes any and all combinations of one or more of the associated listed items.

In descriptions of this application, it should be understood that a direction or a position relationship indicated by terms such as “length”, “width”, “upper”, “lower”, “front”, “back”, “left”, “right”, “vertical”, “horizontal”, “top”, “bottom”, “inside”, or “outside” is a direction or a position relationship shown based on the accompanying drawings, is merely used to facilitate descriptions of this application and simplify the descriptions, but is not intended to indicate or imply that an indicated apparatus or element needs to have a particular direction, and needs to be constructed and operated in a particular direction, and therefore cannot be construed as a limitation on this application.

In addition, it should be noted that, in this specification, the expressions such as “first” and “second” are merely used to distinguish one feature from another, and do not represent any limitation to the feature. Therefore, a first subject discussed below may also be referred to as a second subject without departing from the teachings of this application.

In this application, unless otherwise specified and limited, the terms such as “mount”, “link”, “connect”, “fasten”, and “dispose” should be understood broadly. For example, the term “connect” may be a fixed connection, may be a detachable connection, or may be integration; may be a mechanical connection or may be an electrical connection, or may be a direct connection, may be an indirect connection implemented by using an intermediate medium, or may be communication inside two elements or an interaction relationship between two elements. A person of ordinary skill in the art may interpret specific meanings of the foregoing terms in this application according to specific cases.

In the accompanying drawings, for ease of description, a thickness, a size, and a shape of an object are slightly exaggerated. The accompanying drawings are merely examples and are not drawn strictly to scale.

It should be further understood that, the terms “include”, “comprise”, “have”, “contain”, and/or “involve” are used in this specification to indicate that the stated features, entirety, steps, operations, elements and/or components are present, but this does not exclude existence of or additional one or more other features, entirety, steps, operations, elements, and/or combinations thereof. In addition, when the implementations of this application are described, “may” is used to indicate “one or more implementations of this application”. Moreover, the term “for example” is intended to refer to an example or illustration.

Unless otherwise limited, all terms (including technical and scientific terms) used in this specification have same meanings as understood usually by a person of ordinary skill in the art to which this application belongs. It should be further understood that, terms (such as those defined in common dictionaries) should be interpreted as having meanings consistent with their meanings in the context of related technologies, and will not be interpreted in an idealized or excessive formal sense, unless expressly defined herein.

It should be noted that the embodiments in this application and the features in the embodiments may be mutually combined in the case of no conflict. This application is described below in detail with reference to accompanying drawings and the embodiments.

Currently, in a photographing process of a mobile phone, a captured picture sometimes becomes blurred, that is, the captured picture is not clear enough, and even a ghost or blur case occurs. In addition to occasional out of focus (that is, a camera fails to focus normally), these problems are largely caused by a small jitter during scene shooting and exposure. Generally, this slight jitter often occurs in a handheld condition, resulting in camera lens deviation of a photographing device and quality deterioration of an image captured by an image sensor. Therefore, in recent years, there is a relatively large demand for developing an image stabilization technology. In this background, proposals on an optical image stabilization (OIS) function are also increased. The optical image stabilization function may control the camera lens to move relative to the image sensor to offset and compensate for image offset caused by hand shaking. Generally, an actuating device of an OIS motor includes a voice coil motor (VCM) or an SMA. However, the voice coil motor does not have enough power to push a relatively large and heavy camera lens due to limitation of a size of a mobile phone. In addition, smartphone manufacturers are moving towards a direction of using two or more cameras to enhance image functions, for example, a depth of field function (Bokeh), Zoom application, and three-dimensional (3D) imaging. However, because the voice coil motor has a magnet, there is magnetic interference between two voice coil motors, the voice coil motors cannot be too close, and therefore a design size of the mobile phone is affected. Therefore, advantages of the SMA technology are brought into play. Currently, the SMA technology is applied to the smartphone camera industry, for example, is applied to SMA auto focus (AF) and SMA OIS. A principle of the SMA technology is as follows: An SMA wire is heated by an electric current to transform from a martensite state to an austenite state, and is returned from the austenite state to the martensite state through natural cooling. In terms of saving drive power consumption and conveniently detecting a resistance of the SMA wire, a motor driven by the SMA technology (SMA motor) is best driven by a PWM signal. When the SMA motor and wiring thereof are close to the image sensor and an analog power supply, electromagnetic radiation of the PWM signal causes stripe interference to photographing, and therefore, stripe noise occurs on an image. It is difficult to filter out this kind of stripe noise in later image processing. Therefore, a PWM stripe noise problem of the SMA motor has always been a key problem that restricts and limits large-scale commercial use of the SMA motor.

To resolve the foregoing technical problem, this application provides a camera module, to resolve a stripe noise problem caused by electromagnetic interference in photographing.

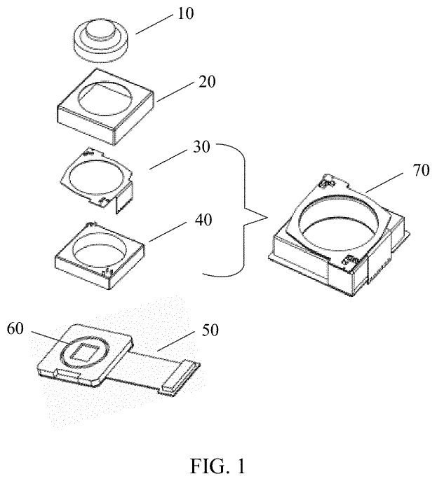

FIG. 1 is a schematic diagram of a structure of a camera module according to an embodiment of this application.

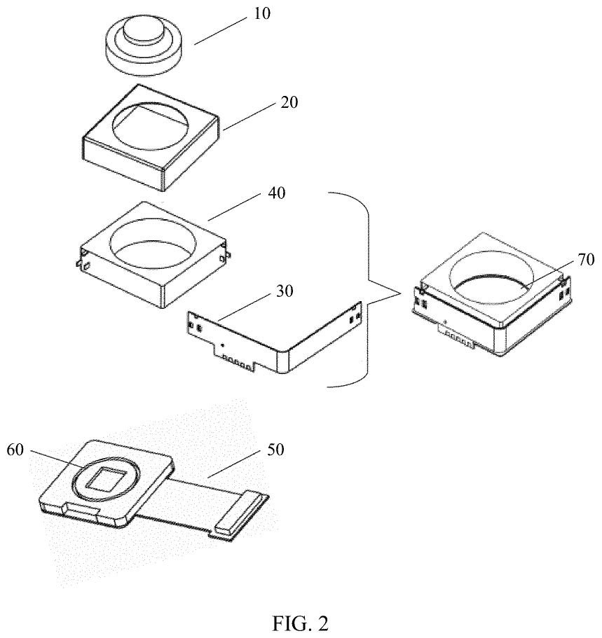

Referring to FIG. 1, the camera module provided in this embodiment of this application includes a camera lens 10, a motor circuit board 30, a motor 40, and an image sensor 60. The camera lens 10 and the motor 40 may be considered as a camera lens assembly, and the motor circuit board 30 and the image sensor 60 are not located on a same side of the camera lens assembly. Further, as shown in FIG. 1, the motor circuit board 30 and the camera lens assembly each have a light passing hole, the camera lens assembly is located between the image sensor 60 and the motor circuit board 30, a light-sensitive surface of the image sensor 60 is located on an image side of the camera lens assembly, and the motor circuit board 30 is located on an object side of the camera lens assembly. Alternatively, as shown in FIG. 2, the motor circuit board 30 may be located on a side of the camera lens assembly, and the image sensor 60 may be located below the camera lens assembly.

In a specific implementation, the camera lens 10 may include a plurality of lenses (concave and convex lenses), that is, imaging is implemented by combining the plurality of camera lenses. The motor 40 may drive the camera lens 10 to perform zoom motion, auto focus motion, or optical image stabilization motion. Further, the motor 40 may include an AF motor or an OIS motor. The AF motor is configured to adjust a camera lens position to photograph objects at different distances, and the OIS motor is configured to adjust a camera lens position, so that an image of a photographed object is not blurred due to, for example, hand shaking of a user. In other words, the camera lens assembly mentioned in this embodiment of this application may have one or more functions of an auto focus function, an automatic zoom function, and an optical image stabilization function.

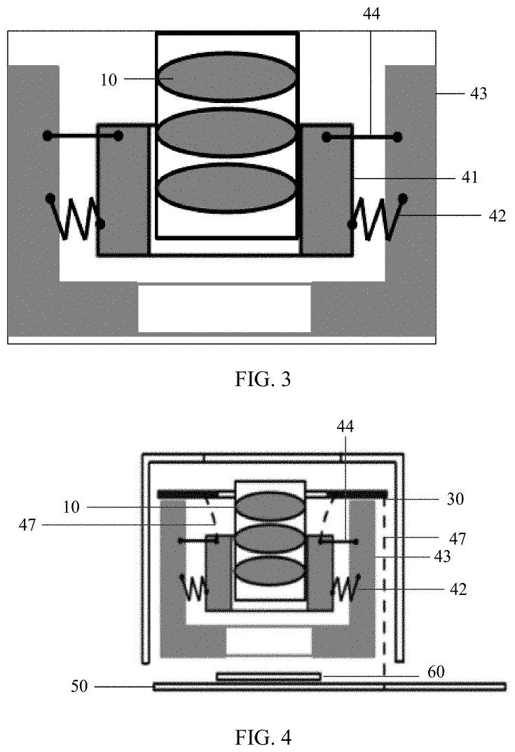

FIG. 3 is a schematic diagram of a structure of the camera lens assembly according to this embodiment of this application. The camera lens assembly includes the motor 40 and the camera lens 10. Three camera lenses shown in FIG. 3 do not represent a limitation to a quantity. The motor 40 includes a fastener 43, a movable part 41, a camera lens support 42, and an actuator 44. One end of the camera lens support 42 is fastened to the fastener 43, and the other end thereof is configured to support the movable part 41, a light passing hole is provided on the movable part 41, and the movable part 41 is configured to mount the camera lens 10, and one end of the actuator 44 is connected to the fastener 43, the other end of the actuator 44 is connected to the movable part 41, and the actuator 44 drives the movable part 41 when the actuator 44 is driven by a signal.

As described in FIG. 1, the motor circuit board 30 and the image sensor 60 are not located on the same side of the camera lens assembly. Further, the motor circuit board 30 may be located above the camera lens assembly and the image sensor 60 may be located below the camera lens assembly, or the motor circuit board 30 may be located on the side of the camera lens assembly and the image sensor 60 may be located below the camera lens assembly. When the motor circuit board 30 is located above the camera lens assembly, the motor circuit board 30 may be fastened above the camera lens assembly in different manners. Alternatively, when the motor circuit board 30 is located on the side of the camera lens assembly, the motor circuit board 30 may be fastened to the side of the camera lens assembly in different manners.

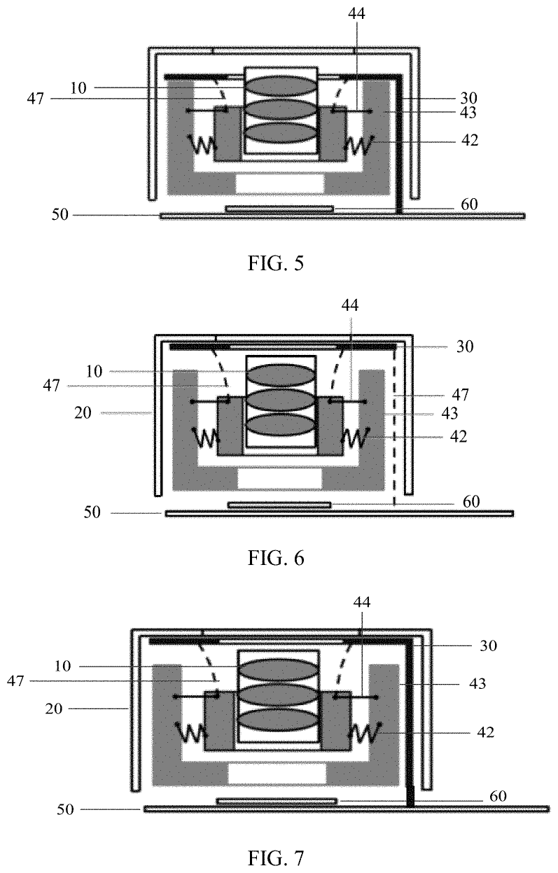

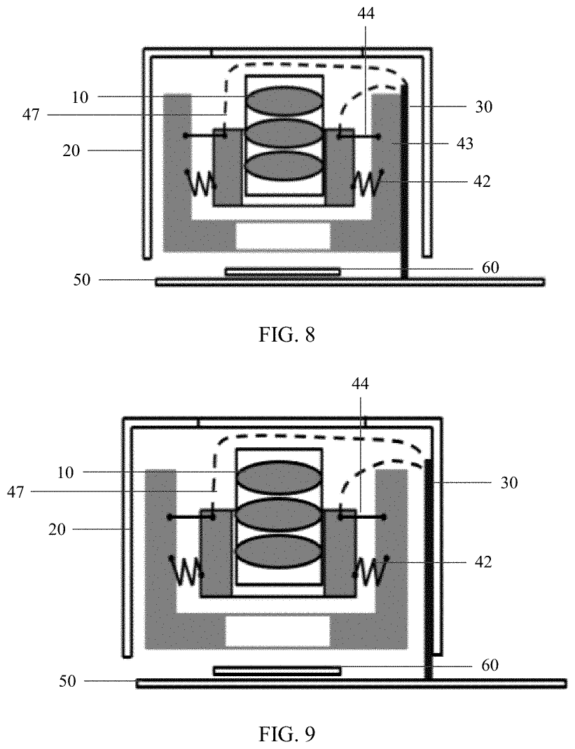

FIG. 4 to FIG. 7 show several fastening manners when the motor circuit board 30 is located above the camera lens assembly according to this embodiment of this application. FIG. 8 and FIG. 9 show several fastening manners when the motor circuit board 30 is located on the side of the camera lens assembly according to this embodiment of this application. As shown in FIG. 4, when the motor circuit board 30 is located above the camera lens assembly, the motor circuit board 30 may be fastened onto the fastener 43, and the motor circuit board 30 may be electrically connected to the movable part 41 and a circuit board 50 by using a lead 47. It should be noted that, a specific quantity of leads is not limited in this application. In another implementation, as shown in FIG. 5, the motor circuit board 30 may be of a bendable structure, so that the motor circuit board 30 can be directly electrically connected to the circuit board 50, and the motor circuit board 30 does not need to be electrically connected to the circuit board 50 by using the lead 47. In another possible implementation, the motor circuit board 30 may also be fastened to a housing.

As shown in FIG. 6 and FIG. 7, the camera module provided in this application may further include a housing 20. The motor circuit board 30 is disposed in the housing 20. In a specific implementation, the motor circuit board 30 may be further fastened to an upper surface of the housing 20. For example, the motor circuit board 30 is fixedly connected to the upper surface of the housing 20 in a welded manner. The welding may be laser welding or another welding manner. This is not limited in this embodiment of this application. Alternatively, the motor circuit board 30 may be detachably connected to the upper surface of the housing 20 by using, for example, a connector such as a screw or a bolt, or may be movably connected to the upper surface of the housing 20 by using, for example, a hinge, or the motor circuit board 30 may be bonded to the upper surface of the housing 20. The bonding may be bonding by using glue or bonding by using another material. This is not limited in this embodiment of this application. The motor circuit board 30 may be electrically connected to the actuator 44 and the circuit board 50 by using the lead 47. It should be noted that, a specific quantity of leads is not limited in this application. In another implementation, as shown in FIG. 7, the motor circuit board 30 may be of a bendable structure, so that the motor circuit board 30 can be directly electrically connected to the circuit board 50, and the motor circuit board 30 does not need to be electrically connected to the circuit board 50 by using the lead 47.

FIG. 8 and FIG. 9 show two fastening manners when the motor circuit board 30 is located on the side of the camera lens assembly according to this embodiment of this application. When the motor circuit board 30 is located on the side of the camera lens assembly, the motor circuit board 30 may be fastened to the fastener 43 of the motor, and the motor circuit board may be electrically connected to the actuator 44 and the circuit board 50 by using the lead 47. In a specific implementation, as shown in FIG. 9, the motor circuit board 30 may be further fastened to a side surface of the housing 20, and the motor circuit board 30 may be electrically connected to the actuator 44 and the circuit board 50 by using the lead 47.

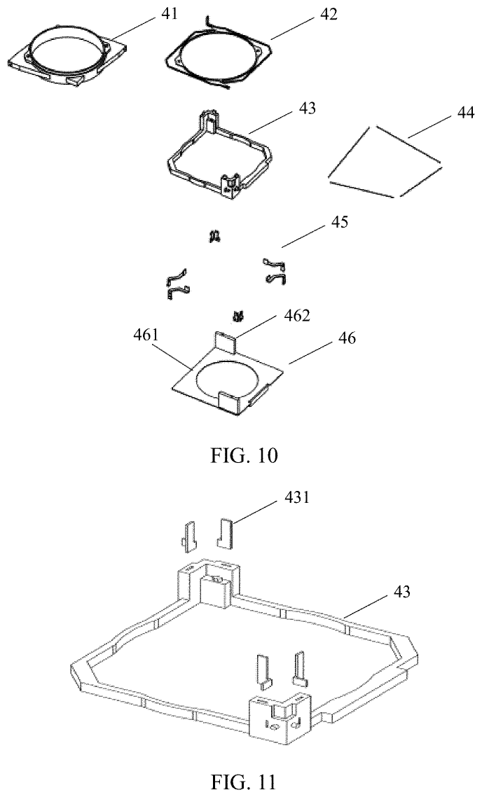

In the structures described in FIG. 4 and FIG. 5, the motor circuit board 30 may be fastened to the fastener 43 of the motor. The following further describes a structure of the fastener 43. The motor 40 may further include a support structure. It should be noted that, the support structure may be a part of the fastener 43. In other words, the support structure and the fastener 43 may be integrated into one. When the fastener 43 includes a base, a raised structure may be disposed along an edge of the base as the support structure. The raised structure may be configured to support the motor circuit board 30, to fix a position of the motor circuit board 30. Alternatively, the support structure may be a separate mechanism. For example, as shown in FIG. 10, an SMA motor is used as an example for description. Further, a support structure 46 may include a base 461 and a positioning component 462. The base 461 has a light passing hole, the base 461 is located on the image side of the camera lens assembly, one end of the positioning component 462 is fastened to the base 461, and the other end thereof is fastened to the motor circuit board 30. There is an accommodating space between the motor circuit board 30 and the motor 40, and the accommodating space is used to accommodate an electronic device on the motor circuit board 30. In a specific implementation, when the motor circuit board 30 is located on a side of the motor 40, the support structure is configured to fasten the motor circuit board 30 on the side of the motor 40. In this scenario, the fastener 43 includes a base and a baffle, the base has a light passing hole, the base is located on the image side of the camera lens assembly, one end of the baffle is connected to the base, the other end thereof is far away from the base, and a surface between two ends of the baffle is fastened to the motor circuit board. 70 in FIG. 1 or FIG. 2 is a schematic diagram of a combination of the motor circuit board 30, the motor 40, and the support structure.

A specific shape of the support structure is not limited in this embodiment of this application. In an actual application process, a structure of the support structure may be set based on an actual requirement, and the support structure is mainly configured to fix the position of the motor circuit board 30. Further, the support structure is configured to fasten the motor circuit board 30 above or on the side of the motor 40.

It should be noted that, when the motor circuit board 30 is a flexible circuit board, to prevent a shape of the motor circuit board 30 from being easily changed, a fastening plate may be further added. The fastening plate has a light passing hole, and the fastening plate may be also referred to as a reinforcing plate. The reinforcing plate is fitted with the motor circuit board, so that the motor circuit board 30 is kept in a fixed shape. The reinforcing plate may further be a shielding plate. It should be further noted that, a fixed connection manner between the motor circuit board 30 and the support structure is not limited. For example, the motor circuit board 30 may be fixedly connected to the support structure in a welded manner. The welding may be laser welding or another welding manner. This is not limited in this embodiment of this application. Alternatively, the motor circuit board 30 may be detachably connected to the support structure by using, for example, a connector such as a screw or a bolt, or may be movably connected to the support structure by using, for example, a hinge, or the motor circuit board 30 may be bonded to the support structure. The bonding may be bonding by using glue or bonding by using another material. This is not limited in this embodiment of this application.

The actuator of the motor 40 may include a SMA drive 44 or may include a piezoelectric drive. When the motor is an motor driven by the SMA, the motor driven by the SMA includes a movable part 41, a fastener 43, a camera lens support 42, and an SMA wire 44, where one end of the camera lens support 42 is fastened to the fastener 43, and the other end thereof is configured to support the movable part 41, a light passing hole is provided on the movable part 41, and the movable part 41 is configured to mount the camera lens 10, one end of the SMA wire 44 is connected to the fastener 43, and the other end of the SMA wire 44 is connected to the movable part 41, the fastener 43 includes a base and a positioning component, the base has a light passing hole, the base is located on the image side of the camera lens assembly, one end of the positioning component is fastened to the base, and the other end thereof is fastened to the motor circuit board 30, and there is an accommodating space between the motor circuit board 30 and the motor, and the accommodating space is used to accommodate an electronic device on the motor circuit board 30. When the motor is a piezoelectricity-driven motor, the motor includes a movable part 41, a fastener 43, a camera lens support 42, and a piezoelectric actuator, where one end of the camera lens support 42 is fastened to the fastener 43, and the other end thereof is configured to support the movable part 41, a light passing hole is provided on the movable part 41, and the movable part 41 is configured to mount the camera lens 20, the piezoelectric actuator includes a piezoelectric material and a resonator, the piezoelectric material is fastened onto the resonator, and one end of the resonator is fixedly connected to the fastener 43 and the other end thereof is in contact with the movable part 41, or one end of the resonator is in contact with the fastener 43 and the other end thereof is fixedly connected to the movable part 41, the fastener 43 includes a base and a positioning component, the base has a light passing hole, the base is located on the image side of the camera lens assembly, one end of the positioning component is fastened to the base, and the other end thereof is fastened to the motor circuit board 30, and there is an accommodating space between the motor circuit board 30 and the motor 40, and the accommodating space is used to accommodate an electronic device on the motor circuit board 30.

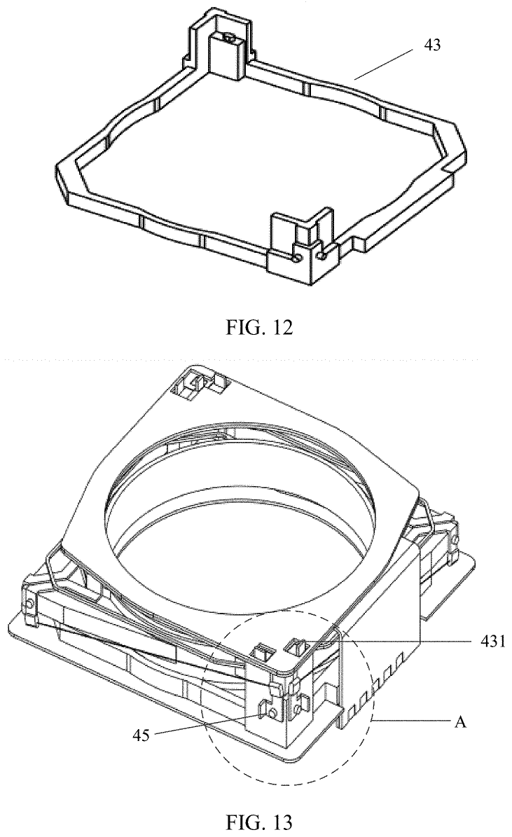

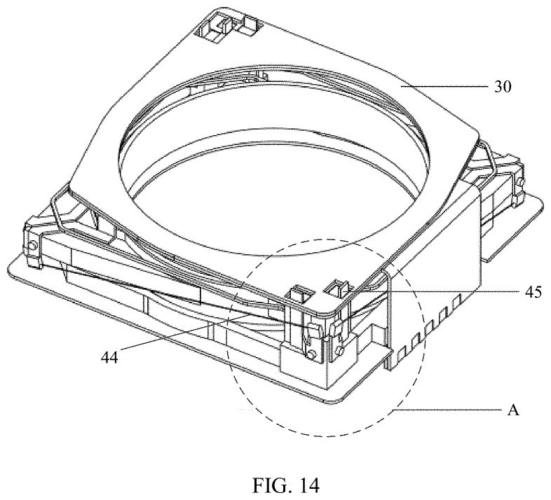

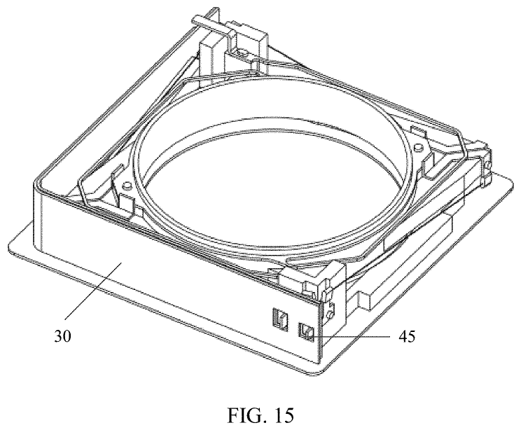

Further, the actuator 44 may be connected to the fastener 43 in a welded manner, or the actuator 44 may be connected to the fastener 43 in a bolted manner, or the actuator 44 may be connected to the fastener 43 by using clamping jaws 45. For example, the SMA motor is used as an example, and an example in which the actuator 44 is connected to the fastener 43 by using the clamping jaws 45 is used for specific description. Further, FIG. 11 and FIG. 12 are respectively schematic diagrams of structures of the fastener 43 of the motor. As shown in FIG. 11, the fastener 43 of the motor includes conductive pins 431. Further, the motor circuit board 30 is electrically connected to the conductive pins 431 of the fastener 43 of the motor. A manner in which the motor circuit board 30 is electrically connected to the conductive pins 431 of the fastener 43 of the motor may include the motor circuit board 30 is electrically connected to the conductive pins 431 in a welded manner, or the motor circuit board 30 is electrically connected to the conductive pins 431 by using conductive adhesive. FIG. 13 is a schematic diagram of a connection between the fastener 43 of the motor and the motor circuit board 30 when the motor circuit board 30 is above the motor. As shown in A of FIG. 13, the clamping jaws 45 are connected to the actuator 44, and the clamping jaws 45 are electrically connected to the conductive pins 431 of the fastener 43 of the motor. Alternatively, FIG. 12 is another schematic diagram of a structure of the fastener 43 of the motor. In the structure shown in FIG. 12, the fastener 43 of the motor may not include the conductive pins 431 shown in FIG. 11. In this case, the actuator 44 and the motor circuit board 30 are no longer connected by using the fastener 43 of the motor. Further, as shown in A of FIG. 14, when the motor circuit board 30 is above the motor 40, the motor circuit board 30 is directly electrically connected to the clamping jaws 45, and the clamping jaws 45 are connected to the actuator 44. When the motor circuit board 30 is on the side surface of the motor 40, FIG. 15 is a schematic diagram of a structure when the motor circuit board 30 is on the side of the motor. For a connection manner between the motor circuit board 30 and the motor 40, refer to the descriptions when the motor circuit board 30 is above the motor 41. Details are not described herein again.

The motor circuit board 30 is connected to the camera lens assembly by using a signal, the motor circuit board 30 has an end part that extends out of the housing 20, and the motor circuit board 30 is connected to the circuit board 50 by using a signal and by using the end part. The circuit board 50 may be a printed circuit board (PCB) or a flexible printed circuit (FPC), or may be another type of circuit board. This is not limited in this embodiment. In this embodiment of this application, the “signal connection” and the “electrical connection” are often used alternately. A person skilled in the art should understand that, when a difference between the “signal connection” and the “electrical connection” is not specifically emphasized, the “signal connection” and the “electrical connection” indicate a same meaning.

After being energized by the circuit board 50, the motor circuit board 30 transmits a PWM signal to the camera lens assembly, where electromagnetic interference intensity of the PWM signal to the image sensor 60 is negatively correlated with a distance between the motor circuit board 30 and the image sensor 60. An image sensor chip may be mounted on the circuit board 50, the image sensor chip may be also referred to as the image sensor 60, and the image sensor 60 is electrically connected to the circuit board 50. It should be noted that, a position of the image sensor may be further fixed by using an epoxy injection encapsulation process. Further, molten epoxy may be injected into a mold by using a high-temperature injection-molding technology. Therefore, the image sensor 60 may be wrapped up. Therefore, a plastic packaging module is formed, and the position of the image sensor is fixed. A welded end of the image sensor in the plastic packaging module is exposed on an active surface of the plastic packaging module.

In this embodiment of this application, the motor circuit board 30 is electrically connected to the circuit board 50, and the motor circuit board 30 is on a side far away from the image sensor 60. In this way, a physical distance between the PWM signal of the motor circuit board 30 and the image sensor 60 is increased, thereby reducing PWM stripe noise.

An embodiment of this application further provides a camera, including the camera module provided in the foregoing embodiment. The camera includes a camera body, a main board, a first mounting part, and a camera module. The first mounting part is disposed on the camera body, and is configured to detachably assemble the camera module. The camera module is electrically connected to the main board, and the camera module is the camera module described in the foregoing content.

An embodiment of this application further provides a mobile terminal, including the camera module provided in the foregoing embodiment. The mobile terminal includes a housing, a main board, and a camera module. The main board is disposed in the housing, a camera of the camera module is disposed at a camera hole of the housing, and the camera module is electrically connected to the main board. The camera module is the camera module described in the foregoing content. It should be understood that, in this embodiment of this application, the mobile terminal may be referred to as user equipment (UE), a mobile station (MS), a terminal, or the like. The mobile terminal may communicate with one or more core networks by using a radio access network (RAN). The mobile terminal may be a mobile phone (or referred to as a “cellular” phone, or the like), a computer with a mobile terminal, or the like. The terminal may alternatively be a portable, pocket-sized, handheld, computer built-in, or in-vehicle mobile apparatus. This is not limited in this application.

The camera module provided in the embodiments of this application is described in detail above. The principles and implementations of this application are described in this specification by using specific examples. The description about the embodiments is merely provided to help understand the method and core ideas of this application. In addition, a person of ordinary skill in the art can make changes in the specific implementations and application scopes based on the ideas of this application. In conclusion, the content of this specification shall not be construed as a limitation on this application.

1. A camera system comprising:
a camera lens assembly comprising:
an object side;
an image side; and
a first light passing hole;
a motor circuit board located on the object side and comprising a second light passing hole; and,
an image sensor comprising a light-sensitive surface located on the image side,
wherein the camera lens assembly is located between the image sensor and the motor circuit board.

2. The camera system of claim 1, wherein the camera lens assembly further comprises:
a camera lens; and
a motor comprising:
a movable part configured to mount the camera lens and comprising a third light passing hole;
a fastener comprising:
a base located on the image side and comprising a fourth light passing hole; and
a positioning component comprising:
a first end fastened to the base; and
a second end fastened to the motor circuit board;
a camera lens support comprising:
a third end fastened to the fastener; and
a fourth end configured to support the movable part; and
an actuator configured to drive the movable part when being driven by a signal and comprising:
a fifth end connected to the fastener; and
a sixth end connected to the movable part.

3. The camera system of claim 1, further comprising a housing comprising a first surface on which the motor circuit board is located, wherein the camera lens assembly further comprises:
a camera lens, wherein a third light passing hole is provided on the first surface corresponding to the camera lens; and
a motor comprising:
a movable part configured to mount the camera lens and comprising a fourth light passing hole;
a fastener;
a camera lens support comprising:
a first end fastened to the fastener;
a second end configured to support the movable part; and
an actuator comprising:
a third end connected to the fastener; and
a fourth end configured to drive the movable part when driven by a signal.

4. The camera system of claim 1, wherein a diameter of the second light passing hole is greater than a diameter of a camera lens of the camera lens assembly.

5. The camera system of claim 1, wherein the motor circuit board further comprises an electronic device, wherein the camera system further comprises an accommodating space between the motor circuit board and a motor of the camera lens assembly, and wherein the accommodating space accommodates the electronic device.

6. The camera system of claim 1, wherein the camera lens assembly further comprises a camera lens and a motor driven by a shape memory alloy (SMA), and wherein the motor comprises:
a movable part configured to mount the camera lens and comprising a third light passing hole;
a fastener comprising:
a base located on the image side and comprising a fourth light passing hole; and
a positioning component comprising:
a first end fastened to the base; and
a second end fastened to the motor circuit board;
a camera lens support comprising:
a third end fastened to the fastener; and
a fourth end configured to support the movable part; and
an SMA wire comprising:
a fifth end connected to the fastener; and
a sixth end connected to the movable part.

7. The camera system of claim 1, wherein the camera lens assembly further comprises a camera lens and a motor, wherein the motor is a piezoelectricity-driven motor, and wherein the motor comprises:
a movable part configured to mount the camera lens and comprising a third light passing hole;
a fastener comprising:
a base located on the image side and comprising a fourth light passing hole; and
a positioning component comprising:
a first end fastened to the base; and
a second end fastened to the motor circuit board;
a camera lens support comprising:
a third end fastened to the fastener; and
a fourth end configured to support the movable part; and
a piezoelectric actuator comprising:
a resonator comprising:
a fifth end connected to the fastener; and
a sixth end in contact with the movable part; and
a piezoelectric material fastened onto the resonator.

8. A camera system comprising:
a camera lens assembly comprising an image side, an object side, a camera lens, a motor, and a first light passing hole;
a motor circuit board located on the image side; and
an image sensor located on the object side, and
wherein either the motor is driven by a shape memory alloy (SMA) and comprising:
a first movable part configured to mount the camera lens and comprising a second light passing hole;
a first fastener;
a first camera lens support comprising:
a first end fastened to the first fastener; and
a second end configured to support the first movable part; and
an SMA wire comprising:
a third end connected to the first fastener; and
a fourth end connected to the first movable part, or
wherein the motor is a piezoelectricity-driven motor and comprising:
a second movable part configured to mount the camera lens and comprising a third light passing hole;
a second fastener;
a second camera lens support comprising:
a fifth end fastened to the second fastener; and
a sixth end configured to support the second movable part; and
a piezoelectric actuator comprising:
a resonator comprising:
a seventh end connected to the second fastener; and
an eight end in contact with the second movable part; and
a piezoelectric material fastened onto the resonator.

9. The camera system of claim 8, wherein the fastener comprises:
a base located on the image side and comprising a fourth light passing hole; and
a baffle comprising:
a ninth end connected to the base; and
a tenth end located far away from the base, wherein a surface between the ninth end and the tenth end is connected to the motor circuit board.

10. The camera system of claim 8, further comprising a housing comprising a first surface on which the motor circuit board is located, wherein a fifth light passing hole is provided on the first surface corresponding to the camera lens.

11. A mobile terminal comprising:
a housing comprising a camera hole;
a main board disposed in the housing; and
a camera system electrically connected to the main board and comprising:
a camera disposed at the camera hole;
a camera lens assembly comprising:
an image side;
an object side; and
a first light passing hole;
a motor circuit board located on the object side and comprising a second light passing hole; and
an image sensor comprising a light-sensitive surface located on the image side,
wherein the camera lens assembly is located between the image sensor and the motor circuit board.

12. The mobile terminal of claim 11, wherein the camera lens assembly further comprises:
a camera lens; and
a motor comprising:
a movable part configured to mount the camera lens and comprising a third light passing hole;
a fastener comprising:
a base located on the image side and comprising a fourth light passing hole; and
a positioning component comprising:
a first end fastened to the base; and
a second end fastened to the motor circuit board;
a camera lens support comprising:
a third end fastened to the fastener; and
a fourth end configured to support the movable part; and
an actuator configured to drive the movable part when being driven by a signal and comprising:
a fifth end connected to the fastener; and
a sixth end connected to the movable part.

13. The mobile terminal of claim 11, wherein the camera system further comprises a housing comprising a first surface on which the motor circuit board is located, and wherein the camera lens assembly further comprises:
a camera lens, wherein a third light passing hole is provided on the first surface corresponding to the camera lens; and
a motor comprising:
a movable part configured to mount the camera lens and comprising a fourth light passing hole;
a fastener;
a camera lens support comprising:
a first end fastened to the fastener; and
a second end configured to support the movable part; and
an actuator comprising:
a third end connected to the fastener; and
a fourth end that drives the movable part when driven by a signal.

14. The mobile terminal of claim 11, wherein a diameter of the second light passing hole is greater than a diameter of a camera lens of the camera lens assembly.

15. The mobile terminal of claim 11, wherein the motor circuit board further comprises an electronic device, wherein the camera system further comprises an accommodating space between the motor circuit board and a motor of the camera lens assembly, and wherein the accommodating space accommodates the electronic device.

16. The mobile terminal of claim 11, wherein the camera lens assembly further comprises a camera lens and a motor driven by a shape memory alloy (SMA), and wherein the motor comprises:
a movable part configured to mount the camera lens and comprising a third light passing hole,
a fastener comprising:
a base located on the image side and comprising a fourth light passing hole; and
a positioning component comprising a first end fastened to the base and a second end fastened to the motor circuit board;
a camera lens support comprising:
a third end fastened to the fastener; and
a fourth end configured to support the movable part; and
an SMA wire comprising:
a fifth end connected to the fastener; and
a sixth end connected to the movable part.

17. The mobile terminal of claim 11, wherein the camera lens assembly further comprises a camera lens and a motor, wherein the motor is a piezoelectricity-driven motor, and wherein the motor comprises:
a movable part configured to mount the camera lens and comprising a third light passing hole;
a fastener comprising:
a base located on the image side and comprising a fourth light passing hole; and
a positioning component comprising a first end fastened to the base and a second end fastened to the motor circuit board;
a camera lens support comprising:
a third end fastened to the fastener; and
a fourth end configured to support the movable part; and
a piezoelectric actuator comprising:
a resonator comprising:
a fifth end connected to the fastener; and
a sixth end in contact with the movable part; and
a piezoelectric material fastened onto the resonator.

18. The mobile terminal of claim 11, wherein the camera lens assembly further comprises a camera lens and a motor, wherein the motor is a piezoelectricity-driven motor and comprising:
a movable part configured to mount the camera lens and comprising a third light passing hole;
a fastener comprising:
a base located on the image side and comprising a fourth light passing hole; and
a positioning component comprising a first end fastened to the base and a second end fastened to the motor circuit board;
a camera lens support comprising:
a third end fastened to the fastener; and
a fourth end configured to support the movable part; and
a piezoelectric actuator comprising:
a resonator comprising:
a fifth end in contact with the fastener; and
a sixth end connected to the movable part; and
a piezoelectric material fastened onto the resonator.

19. The camera system of claim 1, wherein the camera lens assembly further comprises a camera lens and a motor, wherein the motor is a piezoelectricity-driven motor and comprising:
a movable part configured to mount the camera lens and comprising a third light passing hole;
a fastener comprising:
a base located on the image side and comprising a fourth light passing hole; and
a positioning component comprising a first end fastened to the base and a second end fastened to the motor circuit board;
a camera lens support comprising:
a third end fastened to the fastener; and
a fourth end configured to support the movable part; and
a piezoelectric actuator comprising:
a resonator comprising:
a fifth end in contact with the fastener; and
a sixth end connected to the movable part; and
a piezoelectric material fastened onto the resonator.

20. The camera system of claim 2, wherein the signal is a pulse-width modulation (PWM) driving signal.
